(19) United States
(12) Patent Application Publication
(10) Pub. No.: US 2025/0171633 A1
(43) Pub. Date: May 29, 2025

(54) EASY FLOW THERMOPLASTIC POLYURETHANE (TPU)

(71) Applicant: BASF SE, Ludwigshafen am Rhein (DE)

(72) Inventors: Nabarun ROY, Lemfoerde (DE); Mark D. SWARTZLANDER, Wyandotte, MI (US); Brad J. MARTIN, Dearborn, MI (US); Martin FABER, Emmen (NL); Albert DE BOER, Emmen (NL)

(21) Appl. No.: 18/851,120

(22) PCT Filed: Mar. 30, 2023
(86) PCT No.: PCT/US2023/065119

§ 371 Date: Sep. 26, 2024

Related U.S. Application Data
(60) Provisional application No. 63/325,214, filed on Mar. 30, 2022.

(51) Int. Cl. C08L 75/04; B29C 64/118; B29K 75/00; B29K 105/00; B33Y 10/00; B33Y 70/00

(52) U.S. Cl. CPC C08L 75/04; B29C 64/118; B33Y 10/00; B33Y 70/00; B29K 2075/00; B29K 2105/0094; B29K 2995/0012; B29K 2995/0077

(57) ABSTRACT

Described herein is a thermoplastic polyurethane (TPU) composition suitable for 3D printing, or additive manufacturing technologies, among others. Specifically, the present disclosure relates to a TPU composition with high melt flow and low viscosity. The present disclosure further provides a filament comprising the TPU composition. The filament is suitable for 3D printing

### TECHNICAL FIELD

The present disclosure relates to a thermoplastic polyurethane (TPU) composition suitable for 3D printing, or additive manufacturing technologies, among others. Specifically, it is related to a TPU composition with high melt flow and low viscosity, without significant impact on parts printed using the composition. The present disclosure further relates to a filament comprising the TPU composition. The filament is suitable for 3D printing.

### BACKGROUND OF THE INVENTION

In the discussion of the background that follows, reference is made to certain structures and/or methods. However, the following references should not be construed as an admission that these structures and/or methods constitute prior art. Applicant expressly reserves the right to demonstrate that such structures and/or methods do not qualify as prior art.

Thermoplastic polyurethane (TPU) is a thermoplastic elastomer generally consisting of block copolymers comprising hard and soft segments. Some TPUs, particularly harder TPUs used in the manufacture of thin-walled parts and three-dimensional (3D) printing may display poor flowability, leading to difficulties in processing or use in printers.

### BRIEF SUMMARY OF THE INVENTION

In a first embodiment is described a composition comprising:
a thermoplastic polyurethane (TPU); and
a flow enhancer of the formula:

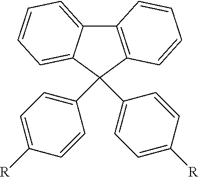

wherein R is OR¹; and
R¹ may be hydrogen, branched or unbranched C₁-C₆ alkyl, branched or unbranched C₁-C₆ alkoxy, or branched or unbranched C₁-C₆ hydroxyalkyl.

In a second embodiment is described the composition of embodiment 1, wherein the thermoplastic polyurethane (TPU) is a polyester thermoplastic polyurethane (TPU).

In a third embodiment is described the composition of embodiment 1, wherein the thermoplastic polyurethane (TPU) is a polyether thermoplastic polyurethane (TPU).

In a fourth embodiment is described the composition of any one of embodiments 1 to 3, wherein the flow enhancer is present in an amount of about 0.1 wt. % to about 5 wt. %, based on the total weight of the composition.

In a fifth embodiment is described the composition of any one of embodiments 1 to 4, wherein the thermoplastic polyurethane (TPU) further comprises a matting agent.

In a sixth embodiment is described a filament comprising the composition of any one of embodiments 1 to 5.

In a seventh embodiment is described the filament of embodiment 6, wherein the melt viscosity of the filament at 200° C. is from 2500 mPa·s to 10,000 mPa·s.

In an eighth embodiment is described the filament of either embodiment 6 or embodiment 7, wherein the peak tensile strength of the filament is from 3500 psi to 4800 psi.

In a ninth embodiment is described the filament of any one of embodiments 6 to 8, wherein the percent elongation of the filament is from 275% to 750%.

In a tenth embodiment is described a 3D printed article comprising the filament of any one of embodiments 6 to 9.

### BRIEF DESCRIPTION OF THE DRAWINGS

FIG. 1A shows viscosity versus shear rate for several formulations, as described in Example 3.

FIG. 1B shows viscosity versus shear rate for several formulations, as described in Example 3.

FIG. 2A shows the mass of extruded filament versus printing speed for two formulations, as described in Example 4.

FIG. 2B shows the mass of extruded filament versus printing speed for three formulations, as described in Example 4.

FIG. 2C shows the mass of extruded filament versus printing speed for two formulations, as described in Example 4.

FIG. 3A shows a comparison of 3D printed objects made from several formulations, as described in Example 7.

FIG. 3B shows a comparison of the interior of 3D printed objects made from several formulations, as described in Example 7.

### DEFINITIONS

Prior to describing the invention in further detail, the terms used in this application are defined as follows unless otherwise indicated.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

“Optional” or “optionally” means that the subsequently described circumstance may or may not occur, so that the description includes instances where the circumstance occurs and instances where it does not.

The term “pre-determined” refers to an element whose identity is known prior to its use.

### DETAILED DESCRIPTION OF THE INVENTION

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The present disclosure provides a composition comprising thermoplastic polyurethane (TPU) and a melt flow modifier.

The TPU may comprise polyether TPU or polyester TPU. In an embodiment, the TPU may be formed from at least one polyisocyanate and at least one polyester polyol, wherein the polyester polyol is formed from at least one polyhydric alcohol and a mixture of two or more dicarboxylic acids.

The polyurethane may include further components, for example at least one chain extender or else hydrolysis control agents, antioxidants, UV stabilizers, plasticizers, organic or inorganic fillers, demolding assistants, and also further customary additives.

The polyester polyols may have an average functionality in the range from 1.8 to 2.3, more preferably in the range from 1.9 to 2.2 and especially equal to 2. The polyester polyol may be a polyester diol. Accordingly, in a further embodiment, the present invention provides a polyurethane based on at least one polyisocyanate and at least one polyester diol, wherein the polyester diol is based on at least one polyhydric alcohol and a mixture of two or more dicarboxylic acids.

Suitable molecular weight ranges for the polyester polyols employed for the purposes of the present invention are known per se to a person skilled in the art. In one preferred embodiment, the molecular weight of the polyester polyol is in the range from 500 to 4000 g/mol, more preferably in the range from 800 and 3000 g/mol and most preferably in the range from 1000 and 2500 g/mol.

Particularly suitable polyester polyols for the purposes of the present invention have an OH number in the range from 25 to 230 mg KOH/g, more preferably in the range from 35 to 140 mg KOH/g and most preferably in the range from 40 to 115 mg KOH/g

The polyester polyol may be based on a polyhydric alcohol. Suitable polyhydric alcohols include, for example, polyhydric aliphatic alcohols, for example aliphatic alcohols having 2, 3, 4 or more OH groups, for example 2 or 3 OH groups. Suitable aliphatic alcohols for the purposes of the present invention include, for example, C2 to C12 alcohols, preferably C2 to C8 alcohols and most preferably C2 to C6 alcohols. It is preferable for the purposes of the present invention for the polyhydric alcohol to be a diol, and suitable diols are known per se to a person skilled in the art.

Suitable aliphatic C2 to C6 diols may include, for example, ethylene glycol, diethylene glycol, 3-oxapentane-1,5-diol, 1,3-propanediol, 1,2-propanediol, dipropylene glycol, 1,4-butanediol, 1,5-pentanediol, 1,6-hexanediol, 2-methyl-1,3-propanediol and 3-methyl-1,5-pentanediol. It is further preferable for the polyhydric alcohol to be selected from the group consisting of 1,3-propanediol and 1,4-butanediol.

Alcohols having three or more OH groups can also be used to enhance the functionality of the polyester polyols. Examples of alcohols having three or more OH groups are glycerol, trimethylolpropane and pentaerythritol. It is also possible to use oligomeric or polymeric products having two or more hydroxyl groups. Examples thereof are polytetrahydrofuran, polylactones, polyglycerol, polyetherols, polyesterol or α,ω-dihydroxypolybutadiene.

The polyester polyol may be based not only on least one polyhydric alcohol but also on a mixture of two or more dicarboxylic acids. Suitable dicarboxylic acids for preparing polyester polyols are known per se to a person skilled in the art.

The present invention may utilize a mixture of two or more dicarboxylic acids, for example a mixture of two, three or four dicarboxylic acids. A mixture of two or three different dicarboxylic acids selected from the group of C2 to C12 dicarboxylic acids may be used, for example. By C2 to C12 dicarboxylic acids are meant dicarboxylic acids which are aliphatic, straight-chain or branched, and have two to twelve carbon atoms. It is also possible for dicarboxylic acids, such as C2 to C14 dicarboxylic acids, preferably C4 to C12 dicarboxylic acids and more preferably C6 to 10 dicarboxylic acids, to be used in the compositions described herein.

One or more of the dicarboxylic acids employed for the purposes of the present invention may also be in the form of a carboxylic diester or in the form of a carboxylic anhydride. Aliphatic and/or aromatic dicarboxylic acids may in principle be employed as dicarboxylic acid.

The mixing ratio between the dicarboxylic acids employed in the mixture may vary between wide limits for the purposes of the present invention. Expressed in mol % for the two or more dicarboxylic acids, this mixing ratio may be in the range from 90:10 to 10:90, more preferably from 80:20 to 20:80 and most preferably from 70:30 to 30:70.

The ratio of the components employed in the polyester TPU compositions described herein may in principle vary between wide limits. This ratio of the components employed is typically described by the ratio of NCO groups to OH groups, the OH groups being the sum total of the OH groups for the employed polyester polyol, chain extender and any further additives. The ratio of NCO to OH groups in the present invention is in the range from 0.9 to 1.1 for example and is preferably in the range from 0.95 to 1.05.

The thermoplastic polyurethanes (TPUs) of the present disclosure may be prepared by reacting the isocyanate with the polyester polyol, optional further isocyanate-reactive compounds, and optional chain-extending agents, in the presence or absence of catalysts and/or customary assistants.

In an embodiment, the TPU comprises less than 15 mol. % of aromatic monomers, more preferably less than 10 mol. %, and still more preferably less than 3 mol. %, based on the total TPU composition.

Suitable isocyanates may include aromatic, aliphatic, cycloaliphatic and/or araliphatic isocyanates, preferably diisocyanates, such as 2,2′-, 2,4′- and/or 4,4′-diphenylmethane diisocyanate (MDI), 1,5-naphthylene diisocyanate (NDI), 2,4- and/or 2,6-tolylene diisocyanate (TDI), diphenylmethane diisocyanate, 3,3′-dimethyldiphenyl diisocyanate, 1,2-diphenylethane diisocyanate and/or phenylene diisocyanate, tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1-isocyanato-4-[(4-isocyanatocyclohexyl)methyl]cyclohexane (H12MDI), 2,6-diisocyanatohexanecarboxylic ester, 1,4- and/or 1,3-bis(isocyanatomethyl)cyclohexane (HXDI), 1,4-cyclohexane diisocyanate, 1-methyl-2,4- and/or -2,6-cyclohexane diisocyanate and/or 4,4′-, 2,4′- and 2,2′-dicyclohexylmethane diisocyanate, preferably 2,2′-, 2,4′- and/or 4,4′-diphenylmethane diisocyanate (MDI), 1,5-naphthylene diisocyanate (NDI), 2,4- and/or 2,6-tolylene diisocyanate (TDI), hexamethylene diisocyanate, 1-isocyanato-4-[(4-isocyanatocyclohexyl)methyl]cyclohexane, and/or IPDI, more particularly 4,4′-MDI and/or hexamethylene diisocyanate and/or H12MDI.

In one further embodiment, the present invention also provides a polyurethane as described above wherein the polyisocyanate employed for preparation is selected from the group consisting of 2,2′-, 2, 4′- and 4,4′-diphenylmethane diisocyanate (MDI), 2,4- and 2,6-tolylene diisocyanate (TDI), hexamethylene diisocyanate and 1-isocyanato-4-[(4-isocyanatocyclohexyl)methyl]cyclohexane (H12MDI).

Suitable chain extenders may include aliphatic, araliphatic, aromatic and/or cycloaliphatic compounds having a molecular weight of 50 to 499 g/mol, preferably 2-functional compounds, examples being alkanediols having 2 to 10 carbon atoms in the alkylene radical, preferably 1,4-butanediol, 1,6-hexanediol and/or di-, tri-, tetra-, penta-, hexa-, hepta-, octa-, nona- and/or decaalkylene glycols of 3 to 8 carbon atoms, preferably unbranched alkanediols, more particularly 1,3-propanediol and 1,4-butanediol.

For the purposes of the present invention, the chain extender may be selected from the group consisting of aliphatic C2-C6 diols, more preferably from the group consisting of 1,3-propanediol, 1,4-butanediol and 1,6-hexanediol.

In one further embodiment, the present invention also provides a polyurethane as described above wherein the at least one chain extender is selected from the group consisting of C2 to C6 diols.

Suitable catalysts for speeding in particular the reaction between the NCO groups of the polyisocyanates and the polyol component are the customary compounds which are known from the prior art and are derivable from the literature. Examples of suitable catalysts in the context of the present invention are tertiary amines, for example triethylamine, dimethylcyclohexylamine, N-methylmorpholine, N,N′-dimethylpiperazine, 2-(dimethylaminoethoxy)ethanol, diazabicyclo (2,2,2)octane and the like and also, more particularly, organic metal compounds such as titanic esters, iron compounds such as, for example, iron(VI) acetylacetonate, tin compounds, for example tin diacetate, tin dioctoate, tin dilaurate or the tin dialkyl salts of aliphatic carboxylic acids such as dibutyltin diacetate, dibutyltin dilaurate or the like. The catalysts are customarily used in amounts of 0.00001 to 0.1 part by weight per 100 parts by weight of polyhydroxy compound.

In addition to catalysts, the structural components, i.e., the polyols, isocyanates and chain extenders, may also have added to them customary auxiliaries. Examples are blowing agents, surface-active substances, flame retardants, nucleating agents, lubricating and demolding aids, dyes and pigments, stabilizers, for example against hydrolysis, light, heat or discoloration, inorganic and/or organic fillers, reinforcing agents, plasticizers and metal deactivators. Hydrolysis control agents used are preferably oligomeric and/or polymeric aliphatic or aromatic carbodiimides. To stabilize the polyurethane of the present invention against aging, the polyurethane preferably has stabilizers added to it. Stabilizers for the purposes of the present invention are additives which protect a plastic or a plastic mixture against harmful environmental effects. Examples are primary and secondary antioxidants, thiosynergists, organophosphorus compounds of trivalent phosphorus, hindered amine light stabilizers, UV absorbers, hydrolysis control agents, quenchers and flame retardants. Examples of commercial stabilizers are given in Plastics Additive Handbook, 5th Edition, H. Zweifel, ed., Hanser Publishers, Munich, 2001, p. 98-p. 136.

When the polyurethane of the present invention is exposed to thermal oxidative damage, during use, antioxidants can be added. Preference is given to using phenolic antioxidants. Examples of phenolic antioxidants are given in Plastics Additive Handbook, 5th edition, H. Zweifel, ed, Hanser Publishers, Munich, 2001, pp. 98-107 and p. 116-p. 121. Preference is given to phenolic antioxidants having a molecular weight greater than 700 g/mol. One example of a phenolic antioxidant which is preferably used is pentaerythrityl tetrakis (3-(3,5-bis(1,1-dimethylethyl)-4-hydroxyphenyl)propionate) (Irganox® 1010) or other high molecular weight condensation products formed from corresponding antioxidants. The phenolic antioxidants are generally used in concentrations of between 0.1% and 5% by weight, preferably between 0.1% and 2% by weight and especially between 0.5% and 1.5% by weight, all based on the total weight of the polyurethane. Preference is further given to using antioxidants which are amorphous or liquid.

Although the polyurethanes of the present invention are by virtue of their preferable composition distinctly more stable to ultraviolet radiation than, for example, polyurethanes plasticized with phthalates or benzoates, stabilization with phenolic stabilizers only is often insufficient. For this reason, the polyurethanes of the present invention which are exposed to UV light are preferably additionally stabilized with a UV absorber. UV absorbers are molecules which absorb high energy UV light and dissipate the energy. UV absorbers widely used in industry belong for example to the group of the cinnamic esters, the diphenyl cyanoacrylates, the oxamides (oxanilides), more particularly 2-ethoxy-2′-ethyloxanilide, the formamidines, the benzylidenemalonates, the diarylbutadienes, triazines and also the benzotriazoles. Examples of commercial UV absorbers are given in Plastics Additive Handbook, 5th edition, H. Zweifel, ed, Hanser Publishers, Munich, 2001 pp. 116-122.

In a preferred embodiment, the UV absorbers have a number average molecular weight greater than 300 g/mol and more particularly greater than 390 g/mol. Furthermore, the UV absorbers which are preferably used should have a molecular weight of not greater than 5000 g/mol and more preferably of not greater than 2000 g/mol. The group of the benzotriazoles is particularly useful as UV absorbers. Examples of particularly useful benzotriazoles are Tinuvin® 213, Tinuvin® 328, Tinuvin® 571, and also Tinuvin® 384 and Eversorb® 82. The UV absorbers are preferably added in amounts between 0.01′)/0 and 5% by weight, based on the total mass of polyurethane, more preferably between 0.1% and 2.0% by weight and especially between 0.2% and 0.5% by weight, all based on the total weight of the polyurethane. Often, an above-described UV stabilization based on an antioxidant and a UV absorber is still not sufficient to ensure good stability for the polyurethane of the present invention against the harmful influence of UV rays. In this case, a hindered amine light stabilizer (HALS) can preferably be added in addition to the antioxidant and the UV absorber. A particularly preferred UV stabilization comprises a mixture of a phenolic stabilizer, a benzotriazole and a HALS compound in the above-described preferred amounts. However, it is also possible to use compounds which combine the functional groups of the stabilizers, for example sterically hindered piperidylhydroxybenzyl condensation products such as for example di(1,2,2,6,6-pentamethyl-4-piperidyl) 2-butyl-2-(3,5-di-tert-butyl-4-hydroxybenzyl) malonate, Tinuvin® 144.

Particular suitability also extends to waxes which perform important functions not only in the industrial production of the polyurethanes but also in their processing. The wax serves as a friction-reducing internal and external lubricant and thus improves the flow properties of the polyurethane. In addition, it is said to act as a release agent preventing the adherence of polyurethane to the surrounding material (the mold for example), and as a dispersant for other added substances, for example pigments and antiblocking agents. Suitable are for example fatty acid esters, such as stearic esters and montan esters and their metal soaps, but also fatty acid amides, such as stearylamides and oleamides, or else polyethylene waxes. An overview of waxes used in thermoplastics is given in H. Zweifel (Ed.): Plastics Additives Handbook, 5th edition, Hanser Verlag, Munich 2001, pp. 443 if., EP-A 308 683, EP-A 670 339 and JP-A 5 163 431.

It is further also possible to add ester and amide combinations as per DE-A 19 607 870 and wax mixtures of montan acid and fatty acid derivatives (DE-A 196 49 290), and also hydroxy-stearylamides as per DE 10 2006 009 096 A1.

A particularly preferred embodiment utilizes fatty acids as per DE-A-19706452 of 24 to 34 carbon atoms and/or esters and/or amides of these fatty acids in the case of polyurethanes with desired reduced tendency to take up and/or give off substances, for which the fatty acids and/or their derivatives are used in a weight fraction of 0.001 to 15 wt %, based on the total weight of the polyisocyanate polyaddition products. A further preferred embodiment utilizes a mixture as per EP-A-1826225 of the reaction products of alkylenediamines with a) one or more linear fatty acids and of alkylenediamines with b) 12-hydroxystearic acid and/or of the reaction products of alkylenediamines with c) 12-hydroxystearic acid and one or more linear fatty acids. This mixture thus comprises the reaction products of alkylenediamine with a) and b) and/or c).

Further details about the abovementioned auxiliaries and added substances are derivable from the technical literature, for example from Plastics Additive Handbook, 5th edition, H. Zweifel, ed, Hanser Publishers, Munich, 2001. All molecular weights mentioned in this reference have the unit [g/mol].

It is also possible to add a matting agent to provide the printed filament with a micro rough surface. A particularly preferred embodiment utilizes any suitable matting such as inorganic materials like silica, glass beads, ceria, alumina, magnesia and/or zinc oxide, or polymers that are not miscible with TPU, or that undergo a phase separation with TPU while cooling such as, polyacrylate, polyethylene, polystyrene, polytetrafluoroethene, organic wax, aluminum stearate, calcium stearate, polymethyl methacrylate, or any mixture thereof. It is also possible to use mixtures of inorganic and polymeric matting agents. The matting agent may also be used as a dry blend or in the form of a compound (masterbatch) for the manufacturing of the filament according to this invention. It is also possible to add the matting agent directly during the filament extrusion process to the extruder, for example, in a dissolved form via liquid dosing.

The matting agent may be present in the composition in an amount of about 0.1 wt. % or greater, about 1 wt. % or greater, about 2 wt. % or greater, about 4 wt. % or greater, about 6 wt. % or greater, about 8 wt. % or greater, about 20 wt. % or less, about 18 wt. % or less, about 16 wt. % or less, about 14 wt. % or less, about 12 wt. % or less, or any value or range encompassed by these endpoints, based on the total weight of the composition. A particularly preferred embodiment comprises matting agent in an amount of 4 wt. % to 10 wt. %.

The flow enhancer may comprise a compound of Formula I:

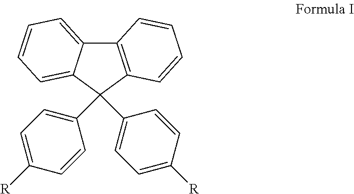

wherein each R independently may be OR¹, C(O)OR¹, CO(O)R¹, NH₂, NHR¹, or NR¹R²; R¹ may be hydrogen, branched or unbranched C₁-C₆ alkyl, branched or unbranched C₂-C₆ alkenyl, branched or unbranched C₂-C₆ alkynyl, branched or unbranched C₁-C₆ alkoxy, branched or unbranched C₁-C₆ hydroxyalkyl, substituted or unsubstituted C₃-C₈ cycloalkyl, substituted or unsubstituted phenyl, or substituted or unsubstituted heteroaryl; and R² may be hydrogen, branched or unbranched C₁-C₆ alkyl, branched or unbranched C₂-C₆ alkenyl, branched or unbranched C₂-C₆ alkynyl, substituted or unsubstituted C₃-C₈ cycloalkyl, substituted or unsubstituted phenyl, or substituted or unsubstituted heteroaryl.

The flow enhancer may be present in the composition in an amount of about 0.1 wt. % or greater, about 0.5 wt. % or greater, about 1 wt. % or greater, about 2 wt. % or greater, about 3 wt. % or less, about 4 wt. % or less, about 5 wt. % or less, or any value or range encompassed by these endpoints, based on the total weight of the composition.

The flow enhancer may also be used as a dry blend or in the form of a compound (masterbatch) for the manufacturing of the filament according to this invention. It is also possible to add the flow enhancer directly during the filament extrusion process to the extruder, for example, in a dissolved form via liquid dosing.

It has been found that modifying TPU with a flow enhancer may lower the softening temperature and increase melt flow rate. The flow enhancer may also decrease the viscosity of the TPU composition. Interestingly, the room temperature properties of the TPU composition are only minimally affected by the addition of the flow enhancer. Without wishing to be bound by theory, it may be that the flow enhancer interferes with the formation of intermolecular hydrogen bonds in the TPU. Alternatively, or additionally, the flow enhancer could be incorporated within the hydrogen bonding network as an acceptor/donor. Thus, flow enhancer may increase the fluidity of the composition.

Due to increased processability, the compositions of the present disclosure may be suitable for use in applications such as TPU filaments, 3D printing, hot melt TPUs, the manufacture of TPU yarn, and the manufacture of thin-walled parts, for example.

Thin-walled parts are usually formed from harder grades of TPU. Often, these materials do not flow well enough to properly fill said parts. The current solution involves heating the material to higher temperatures to reduce the viscosity, but this may result in material degradation and loss of mechanical properties. However, the compositions of the present disclosure permit harder grades of TPU to flow more easily without significantly impacting their room temperature mechanical properties. This represents a distinct advantage for the manufacture of thin-walled parts.

For applications using TPU hot melts, the improved flowability and lower softening temperatures of the compositions of the present disclosure may provide TPU hot melts with better wetting and ultimately improved adhesion.

Production times may be decreased significantly by using the compositions of the present disclosure as these compositions may be used at higher printing speeds in 3D printing, as described further below. Compositions in current use may be challenging to use at higher printing speeds due to their relatively lower melt flow indices. Generally, melting behavior and flow of the TPU may be considered a limiting factor for printing speed.

Compositions in current use in 3D printing may buckle, thereby blocking the nozzle and interfering with printing processes. This is noted particularly at higher printing speed. In contrast, the compositions of the present disclosure the compositions of the present disclosure display less buckling of filaments during 3D printing, allowing for fewer interruptions during the printing process.

The final appearance of 3D printed objects may also be impacted by the composition used in their manufacture. During printing, the material flow must be temporarily stopped when moving between objects, for example. Halting the material flow prevents oozing and the unwanted buildup of excess material. As TPU is a viscoelastic material, this restriction may be particularly difficult when printing with TPU, resulting in the appearance of strands of unwanted material at the edges of objects, among other issues. As discussed further below, the formulations of the present disclosure reduce or remove the presence of undesired excess material between 3D-printed objects.

The compositions of the present disclosure may be particularly suitable for use as filaments for 3D printing. The filament may be described in part by its physical properties, such as melt viscosity, melt flow index (MFI), tensile strength, and percent elongation at break, for example.

The melt viscosity of the filaments of the present disclosure may be about 2500 mPa·s or greater, about 3000 mPa·s or greater, about 3500 mPa·s or greater, about 4000 mPa·s or greater, about 4500 mPa·s or greater, about 5000 mPa·s or greater, about 5500 mPa·s or less, about 6000 mPa·s or less, about 6500 mPa·s or less, about 7000 mPa·s or less, about 7500 mPa·s or less, about 8000 mPa·s or less, about 8500 mPa·s or less, about 9000 mPa·s or less, about 9500 mPa·s or less, about 10,000 mPa·s or less, or any value or range encompassed by these endpoints, as measured at 200° C.

The melt flow index (MFI) of the filaments of the present disclosure may be about 110 g/10 min or greater, about 115 g/10 min or greater, about 120 g/10 min or greater, about 125 g/10 min or greater, about 130 g/10 min or less, about 135 g/10 min or less, about 140 g/10 min or less, about 145 g/10 min or less, about 150 g/10 min or less, about 150 g/m10 min or less, or any value or range encompassed by these endpoints, as measured at 190° C./21.6 kg according to the methods described in ASTM D1238 and ISO 1133.

Alternatively, as measured at 210° C./21.6 kg, the melt flow index (MFI) of the filaments of the present disclosure may be about 240 g/10 min or greater, about 245 g/10 min or greater, about 250 g/10 min or greater, about 255 g/10 min or greater, about 260 g/10 min or greater, about 265 g/10 min or greater, about 270 g/10 min or greater, about 275 g/10 min or greater, about 280 g/10 min or greater, about 285 g/m10 min or greater, about 290 g/10 min or greater, about 295 g/10 min or less, about 300 g/10 min or less, about 305 g/10 min or less, about 310 g/10 min or less, about 315 g/10 min or less, about 320 g/10 min or less, about 325 g/10 min or less, about 330 g/10 min or less, about 335 g/10 min or less, about 340 g/10 min or less, about 345 g/10 min or less, about 350 g/10 min or less, about 355 g/10 min or less, or any value or range encompassed by these endpoints.

The peak tensile strength of the filaments of the present disclosure may be about 3500 psi or greater, about 3600 psi or greater, about 3700 psi or greater, about 3800 psi or greater, about 3900 psi or greater, about 4000 psi or greater, about 4100 psi or less, about 4200 psi or less, about 4300 psi or less, about 4400 psi or less, about 4500 psi or less, about 4600 psi or less, about 4700 psi or less, about 4800 psi or less, or any value or range encompassed by these endpoints.

The percent elongation at break of the filaments of the present disclosure may be about 275% or greater, about 300% or greater, about 325% or greater, about 350% or greater, about 375% or greater, about 400% or greater, about 425% or greater, about 450% or greater, about 475% or greater, about 500% or greater, about 525% or less, about 550% or less, about 575% or less, about 600% or less, about 625% or less, about 650% or less, about 675% or less, about 700% or less, about 725% or less, about 750% or less, or any value or range encompassed by these endpoints.

The filaments of the present disclosure may be used in 3D printing to create 3D printed objects with desirable properties. For example, when the filaments of the present disclosure are used in 3D printing, fewer defects in infill layers are observed in comparison to formulations in current use. Furthermore, when the filaments of the present disclosure are used in 3D printing, less excess material is left behind during retraction in comparison to formulations in current use.

### Example 1: Physical Property Evaluation

Four different formulations of ester TPU and ether TPU, with or without the flow enhancer, were tested for various physical properties, as shown below in Table 1.

TABLE 1

| | | Ester TPU | | Ether TPU | |
|---|---|---|---|---|---|
| | | Flow Enhancer | | | |
| Measurement | Unit | 0% | 3% | 0% | 3% |
| Melt viscosity | mPa · s | 92,000 | 9000 | 29,000 | 3000 |
| (200° C.) | | | | | |
| Flow start T | ° C. | 196 | 187 | 164 | 150 |
| Hardness | A | 95 | 97 | 97 | 97 |
| Spec. Gravity | — | 1.2 | 1.2 | 1.13 | 1.14 |
| Tensile Strength | MPa | 59 | 46 | 49 | 45 |
| Tensile Elongation | % | 470 | 500 | 460 | 520 |
| Modulus at 100% | MPa | 11.3 | 10.7 | 14.1 | 13.5 |
| Elongation | | | | | |
| Tear Strength | kN/m | 132 | 134 | 143 | 142 |
| Impact Resistance | % | 28 | 26 | 28 | 27 |
| Abrasion loss | mm³ | 33 | 49 | 41 | 54 |
| Total light | % | 88.9 | 89.2 | 88.6 | 87.3 |
| transmittance | | | | | |
| Haze | % | 4.5 | 3.3 | 2.2 | 3.8 |

Next, six formulations using polyether TPU from a different commercial source were tested using different amounts of flow enhancer. In each case, a polyether TPU with no added lubricant was used. The results are shown below in Table 2, wherein “85A” pertains to the TPU with a Shore hardness of 85A and “74D” pertains to the TPU with a Shore hardness of 74D.

TABLE 2

| | | TPU | | | | | |
|---|---|---|---|---|---|---|---|
| | | 85A | | | 74D | | |
| | | Flow enhancer | | | | | |
| Measurement | Unit | 0% | 1% | 5% | 0% | 1% | 5% |
| MFI 190° C./21.6 kg | g/10 min | 49 | 145 | 117 | — | — | — |
| MFI 210° C./21.6 kg | g/10 min | — | — | — | 35 | 255 | 345 |
| MFI 210° C./8.7 kg | g/10 min | — | — | — | 8 | 40 | 62 |
| Tensile Strength | psi | — | 4140 | 3920 | — | — | 4150 |
| (peak) | | | | | | | |
| 300% Stress | psi | — | 1718 | 1483 | — | 4579 | 3881 |
| 100% Stress | psi | — | 953 | 900 | — | 4268 | 4023 |
| 50% Stress | psi | — | 693 | 660 | — | 4190 | 4023 |
| Elongation at | % | — | 595 | 664 | — | 186 | 7 |
| Peak Stress | | | | | | | |
| Elongation at Break | % | — | 593 | 683 | — | 362 | 296 |

Next, six formulations using polyester TPU from a different commercial source were tested using different amounts of flow enhancer. In each case, a polyester TPU with no added lubricant was used. The results are shown below in Table 3, wherein “88A” pertains to the TPU with a Shore hardness of 88A and “571D” pertains to the TPU with a Shore hardness of 74D.

TABLE 3

| | | TPU | | | | | |
|---|---|---|---|---|---|---|---|
| | | 88A | | | 57D | | |
| | | Flow enhancer | | | | | |
| Measurement | Unit | 0% | 1% | 5% | 0% | 1% | 5% |
| MFI 190° C./8.7 kg | g/10 min | 20 | 51 | 55 | — | — | — |
| MFI 210° C./3.8 kg | g/10 min | — | — | — | 19 | 72 | 173 |
| Tensile Strength | psi | — | 4000 | 2920 | — | 4780 | 4070 |
| (peak) | | | | | | | |
| 300% Stress | psi | — | 1943 | 1485 | — | 3737 | 3324 |
| 100% Stress | psi | — | 1004 | 903 | — | 2249 | 2177 |
| 50% Stress | psi | — | 725 | 671 | — | 1900 | 1849 |
| Elongation at | % | — | 539 | 548 | — | 348 | 345 |
| Peak Stress | | | | | | | |
| Elongation at Break | % | — | 562 | 638 | — | 477 | 494 |

### Example 2: Melt Flow Index (MFI)

Six compositions were formulated comprising either a polyether TPU or a matt grade polyether TPU, which further comprises a matting agent, and varying amounts of the flow enhancer. The six compositions were then evaluated for melt flow index (MFI) at 210° C./10 kg. The components and MFI for each formulation is shown below in Table 4.

TABLE 4

| | | Additive | MFI |
|---|---|---|---|
| Formulation # | TPU type | (wt. %) | (g/10 min) |
| 1 | Polyether | 0 | 70 |
| 2 | Polyether | 1 | 126 |
| 3 | Polyether | 3 | 265 |
| 4 | Polyether + matting agent | 0 | 58 |
| 5 | Polyether + matting agent | 1 | 239 |
| 6 | Polyether + matting agent | 3 | 846 |

As shown in Table 4, the inclusion of the flow enhancer significantly affects MFI, particularly when the TPU composition includes a matting agent.

### Example 3: Rheological Investigation

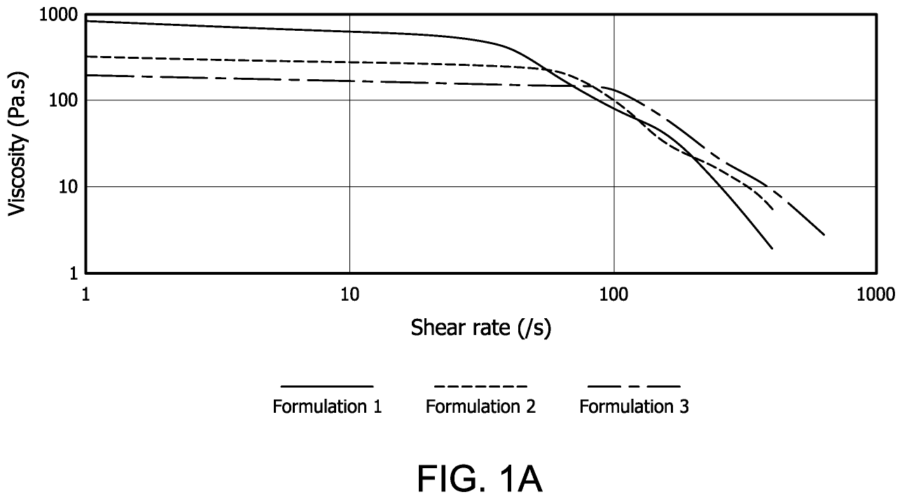

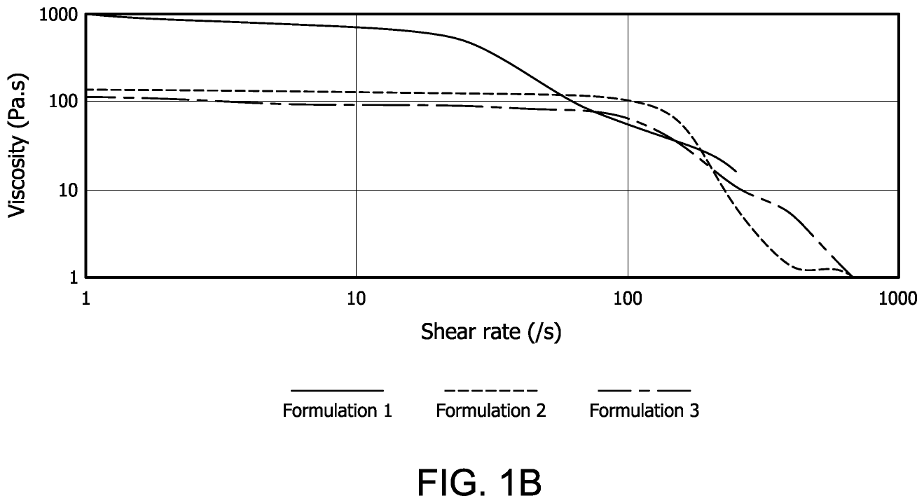

The six formulations described above were then tested for viscosity and shear rate. As shown in FIGS. 1A and 1B, viscosity was reduced when the flow enhancer was present. The presence of the flow enhancer had a greater effect on the formulations on the matt grade TPU. The rheograms shown in FIGS. 1A and 1B show that the Newtonian plateau increases in the presence of the flow enhancer.

### Example 4: Extrusion Testing

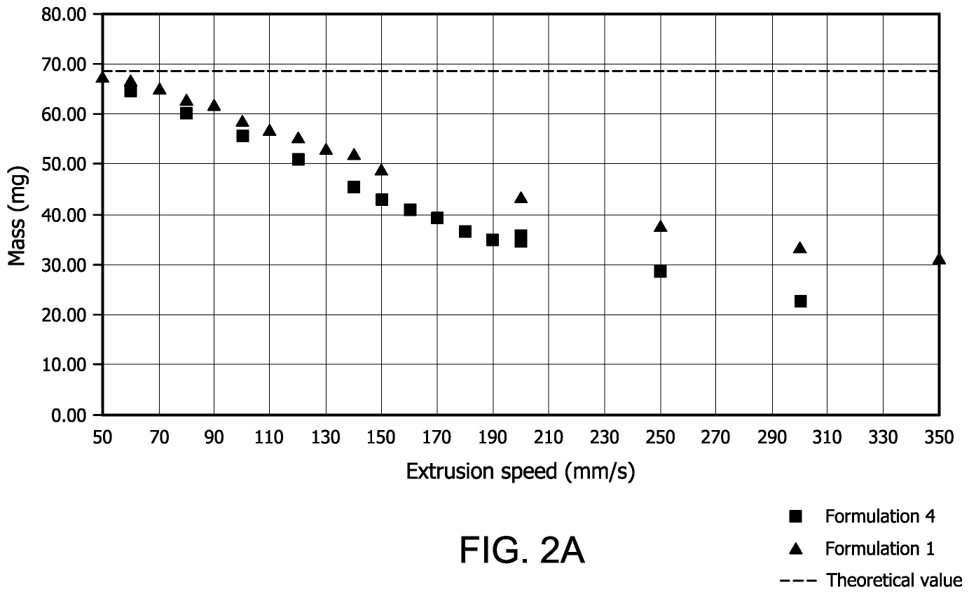

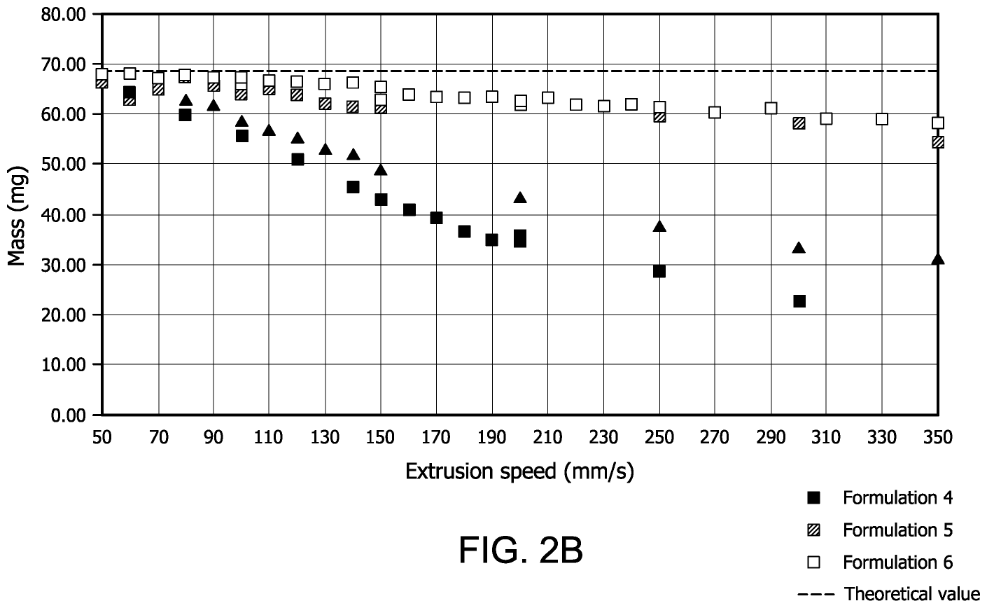

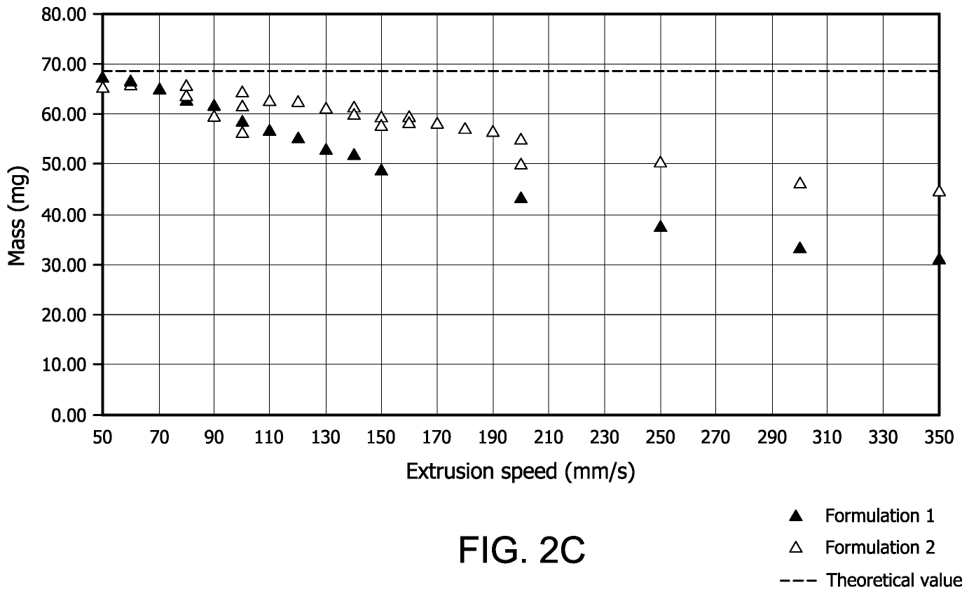

A printer extrusion test was performed by extruding a fixed amount of filament at different printer speeds and comparing the extruded masses. All measurements were performed three times. The printer was a Prusa i3 MK3, operated at an extrusion/printing temperature of 230° C. When Formulations 1 and 4 (those without the flow enhancer) were tested, the extruded mass decreased rapidly as extrusion speed increases. The differences between the two formulations also increase with increasing speed, with the mass of Formulation 4 decreasing faster than that of Formulation 1, as shown in FIG. 2A. Overall, the extruded masses of Formulation 4 are lower than those of Formulation 1, which is reflective of the lower MFI of Formulation 4 (58 g/10 min versus 70 g/10 min for Formulation 1). It is further noted that the gap between the theoretical and experimental values is higher at higher extrusion speeds, as shown in FIG. 2A.

When the flow enhancer is included, as in Formulations 5 and 6, a significant increase in the extruded mass is noted at higher printing speeds as compared to Formulation 4 with no flow enhancer, as shown in FIG. 2B. As seen therein, the extrusion speed appears to have a limited influence on the extruded mass in Formulations 5 and 6. There does not appear to be a significant difference between Formulation 5, with the flow enhancer present in an amount of 1 wt. %, and Formulation 6, in which the flow enhancer is present in an amount of 3 wt. %. The difference between the theoretical value and the experimental values for Formulations 5 and 6 is very small, as shown in FIG. 2B.

Formulation 2 was also tested in the extrusion test. As shown in FIG. 2C, the flow enhancer appeared to have less effect on Formulation 2 than on Formulations 5 and 6, although a significant increase in extruded weight was still noted in comparison to Formulation 1, without the flow enhancer.

Interestingly, flexible filaments formed from Formulations 1 and 4 buckled easily, which none of the formulations containing the flow enhancer displayed this problem.

### Example 6: Printing Speed Evaluation

Five flat squares, each 2 mm in height and areas ranging from 20×20 mm to 100×100 mm were printed. Small surfaces were chosen to limit the maximum printing speed. At larger surface area, there is an increased risk of printing failure. Formulations were evaluated on the basis of how many surfaces could be successfully printed before failure.

At a printing speed of 75 mm/s at 230° C., Formulation 4 failed by the second square. When the printing speed was reduced to 60% (45 mm/s) Formulation 4 was able to print four squares, but still failed by square five. In contrast, Formulation 5 successfully printed all surfaces at a printing speed of 75 mm/s at 230° C.

### Example 7: Retraction Testing

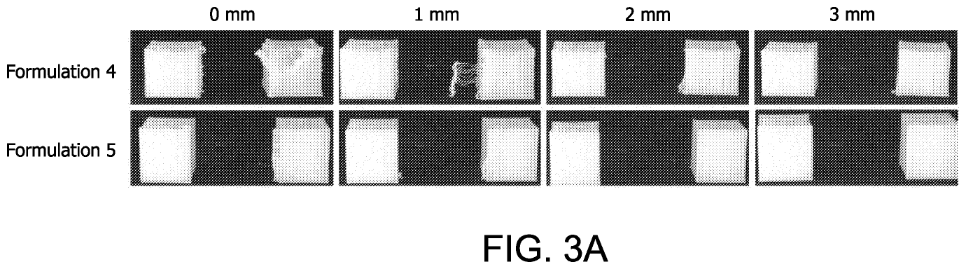

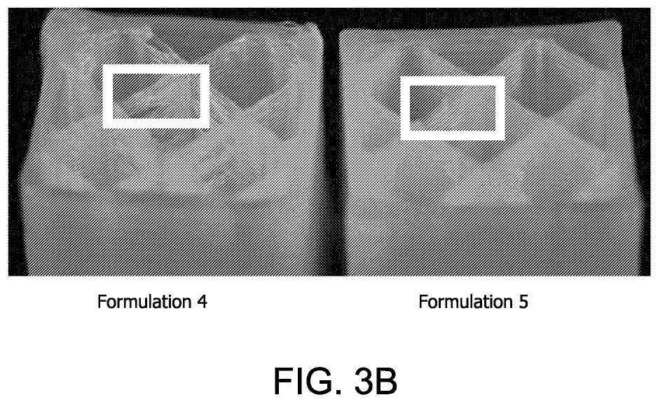

Differences in appearance of 3D printed objects were evaluated using Formulations 4 and 5 at different retraction distances. Two blocks were printed at 230° C., with a print speed of 60 mm/s and a retraction speed of 40 mm/s. Retraction distances of 0 mm, 1 mm, 2 mm, and 3 mm were tested. As shown in FIG. 3A, clear differences were visible between Formulation 4, with no flow enhancer, and Formulation 5, with the flow enhancer present in an amount of 1 wt. %. At a retraction distance of 1 mm, Formulation 5 shows an acceptable result and a perfect result at a distance of 2 mm. In contract, Formulation 4 shows its best result at 3 mm.

As shown in FIG. 3B, further examination of the interior printed objects shows that the blocks printed using Formulation 4 included defects in the infill layers, perhaps due to blocking of the nozzle from the previous layer. In contrast, the interior of the block printed using Formulation 5 showed perfectly extruded infill layers.

1.-13. (canceled)

14. A composition comprising:
a thermoplastic polyurethane (TPU); and
a flow enhancer of the formula: 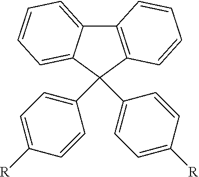
wherein R is OR¹; and
R¹ may be hydrogen, branched or unbranched C₁-C₆ alkyl, branched or unbranched C₁-C₆ alkoxy, or branched or unbranched C₁-C₆ hydroxyalkyl.

15. The composition of claim 14, wherein the thermoplastic polyurethane (TPU) is a polyester thermoplastic polyurethane (TPU).

16. The composition of claim 14, wherein the thermoplastic polyurethane (TPU) is a polyether thermoplastic polyurethane (TPU).

17. The composition of claim 14, wherein the flow enhancer is present in an amount of about 0.1 wt. % to about 5 wt. %, based on the total weight of the composition.

18. The composition of claim 14, wherein the thermoplastic polyurethane (TPU) further comprises a polystyrene matting agent in an amount of about 4 wt. % to about 10 wt. % based on the total weight of the composition.

19. A method for extruding a filament comprising the composition of claim 14.

20. A filament comprising the composition of claim 14.

21. The filament of claim 20, wherein the melt viscosity of the filament at 200° C. is from 2500 mPa·s to 10,000 mPa·s.

22. The filament of either claim 20, wherein the peak tensile strength of the filament is from 3500 psi to 4800 psi.

23. The filament of claim 20, wherein the percent elongation of the filament is from 275% to 750%.

24. A method for extrusion of the filament of claim 20.

25. A method for producing a 3D printed article comprising the filament of claim 20.

26. A 3D printed article comprising the filament of claim 20.
